(19) United States
(12) Patent Application Publication
(10) Pub. No.: US 2020/0217687 A1
(43) Pub. Date: Jul. 9, 2020

(54) CONSOLIDATED VEHICLE NAVIGATION AND INFORMATION SYSTEM

(71) Applicant: SF Motors, Inc., Santa Clara, CA (US)

(72) Inventors: Jaime Camhi, Santa Clara, CA (US); Avery Jutkowitz, Santa Clara, CA (US); Hakuei Huang, Santa Clara, CA (US); Nischitha Mallikarjuna, Santa Clara, CA (US); Ajay Bandi, Santa Clara, CA (US); Joshua Hoffman, Santa Clara, CA (US); Xiaoran Yao, Santa Clara, CA (US)

(21) Appl. No.: 16/243,343

(22) Filed: Jan. 9, 2019

(51) Int. Cl. G01C 21/36

(52) U.S. Cl. CPC G01C 21/3682; G01C 21/3608

(57) ABSTRACT

Provided herein is a consolidated vehicle navigation and information interface for a vehicle. The consolidated interface can include a vehicle based data processing unit coupled with a display module and a navigation application to provide a consolidated interface. The consolidated interface can consolidate a plurality of displays for different systems of the vehicle within the display module. The consolidated interface can include at least one display dedicated to providing the navigation application and a map. The navigation application can provide a plurality of points of interest within the map and receive an input corresponding to an interaction with at least one point of interest. The navigation application can generate a request identifying a third party application corresponding to the point of interest. The request can include a function for the third party application corresponding to a service, product, or data corresponding to the third party application, for example.

### BACKGROUND

Vehicles can include different information systems to provide information related to the vehicle.

### SUMMARY

At least one aspect is directed to a consolidated vehicle navigation and information system, e.g., a consolidated interface. The consolidated interface can include a vehicle based data processing system. The consolidated interface can include a display module communicatively coupled with the vehicle based data processing system. The display module can include a plurality of displays visible within a vehicle. The consolidated interface can include a navigation application coupled with the vehicle based data processing system. The navigation application can be provided within a first display of the plurality of displays. The navigation application can provide a plurality of points of interest corresponding to a location of the vehicle. The navigation application can receive an input corresponding to an interaction with a point of interest of the plurality of points of interest. The navigation application can generate a request responsive the input. The request can identify a third party application corresponding to the point of interest. The request can include a function for the third party application. The vehicle based data processing system can transmit the request including the function to the third party application. The function can correspond to at least one of: a service provided by the third party application, a product provided by the third party application and data corresponding to the third party application. The navigation application can receive content, responsive to the function, from the third party application corresponding to the input. The navigation application can display the content from the third party application within a second display of the plurality of displays. The second display can be provided within a portion of the first display.

At least one aspect is directed to a method of providing a consolidated navigation application within a vehicle. The method can include providing, by a vehicle based data processing system, a plurality of displays of a display module visible within the vehicle. The display module can communicatively couple with the vehicle based data processing system. The method can include executing, by the vehicle based data processing system, a navigation application within a first display of the plurality of displays. The navigation application can provide a plurality of points of interest corresponding to a location of the vehicle. The method can include receiving, by the navigation application, an input corresponding to an interaction with a point of interest of the plurality of points of interest. The method can include generating, by the navigation application, a request responsive the input. The request can identify a third party application corresponding to the point of interest. The request can include a function for the third party application. The method can include transmitting, by the vehicle based data processing system, the request including the function to the third party application. The function can correspond to at least one of: a service provided by the third party application, a product provided by the third party application and data corresponding to the third party application. The method can include receiving responsive to the function, by the vehicle based data processing system, content from the third party application corresponding to the input. The method can include displaying, by vehicle based data processing system, the content from the third party application within a second display of the plurality of displays. The second display can be provided within a portion of the first display.

At least one aspect is directed to a method. The method can provide a consolidated vehicle navigation and information system (“consolidated interface”). The consolidated interface can include a vehicle based data processing system. The consolidated interface can include a display module communicatively coupled with the vehicle based data processing system. The display module can include a plurality of displays visible within a vehicle. The consolidated interface can include a navigation application coupled with the vehicle based data processing system. The navigation application can be provided within a first display of the plurality of displays. The navigation application can provide a plurality of points of interest corresponding to a location of the vehicle. The navigation application can receive an input corresponding to an interaction with a point of interest of the plurality of points of interest. The navigation application can generate a request responsive the input. The request can identify a third party application corresponding to the point of interest. The request can include a function for the third party application. The vehicle based data processing system can transmit the request including the function to the third party application. The function can correspond to at least one of: a service provided by the third party application, a product provided by the third party application and data corresponding to the third party application. The navigation application can receive content, responsive to the function, from the third party application corresponding to the input. The navigation application can display the content from the third party application within a second display of the plurality of displays. The second display can be provided within a portion of the first display.

At least one aspect is directed to an electric vehicle. The electric vehicle can include a consolidated vehicle navigation and information system (“consolidated interface”). The consolidated interface can include a vehicle based data processing system. The consolidated interface can include a display module communicatively coupled with the vehicle based data processing system. The display module can include a plurality of displays visible within a vehicle. The consolidated interface can include a navigation application coupled with the vehicle based data processing system. The navigation application can be provided within a first display of the plurality of displays. The navigation application can provide a plurality of points of interest corresponding to a location of the vehicle. The navigation application can receive an input corresponding to an interaction with a point of interest of the plurality of points of interest. The navigation application can generate a request responsive the input. The request can identify a third party application corresponding to the point of interest. The request can include a function for the third party application. The vehicle based data processing system can transmit the request including the function to the third party application. The function can correspond to at least one of: a service provided by the third party application, a product provided by the third party application and data corresponding to the third party application. The navigation application can receive content, responsive to the function, from the third party application corresponding to the input. The navigation application can display the content from the third party application within a second display of the plurality of displays. The second display can be provided within a portion of the first display.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 is a block diagram depicting a consolidated vehicle navigation and information system within a vehicle, according to an illustrative implementation;

FIG. 2 is a block diagram depicting a consolidated vehicle navigation and information system disposed within a console of a vehicle, according to an illustrative implementation;

FIG. 3 is a block diagram depicting a first layout of a display module of a consolidated vehicle navigation and information system, according to an illustrative implementation;

FIG. 4 is a block diagram depicting a second layout of a display module of a consolidated vehicle navigation and information system, according to an illustrative implementation;

FIG. 5 is a flow diagram depicting an example method of providing a consolidated navigation application within a vehicle;

FIG. 6 is a flow diagram depicting an example method of providing for providing a consolidated navigation application within a vehicle; and

FIG. 7 is a block diagram illustrating an architecture for a computer system that can be employed to implement elements of the systems and methods described and illustrated herein, including, for example, the system depicted in FIGS. 1-4, and the methods depicted in FIGS. 5-6.

### DETAILED DESCRIPTION

Following below are more detailed descriptions of various concepts related to, and implementations of a consolidated vehicle navigation and information system for a vehicle, such as electric vehicles. The various concepts introduced above and discussed in greater detail below can be implemented in any of numerous ways.

Systems and methods described herein relate to a consolidated vehicle navigation and information interface (also referred to herein as “consolidated interface”) for a vehicle. The consolidated interface can include a vehicle based data processing unit coupled with a display module and a navigation application to provide a single interface having a dedicated map corresponding to a geographical location of the vehicle. The consolidated interface can include the dedicated map portion and, within the same common interface, provide a single interface for a user of a vehicle (e.g., driver, passenger) to interact with different systems or applications of the vehicle. For example, the consolidated interface can combine processing power of multiple systems into a single system having a single display to efficiently manage the allocation of computer resources within the vehicle.

The consolidated interface can include a plurality of displays to display content from different system of the vehicle and with at least one of the displays dedicated to providing a navigation application. The navigation application can include a map of a geographical location of the vehicle. For example, the vehicle based data processing system of the consolidated interface can generate the navigation application such that the navigation application is active and visible within the vehicle when the vehicle is on, in use, or otherwise active. Thus, for example, the consolidated interface can provide a navigation application having a map that can be always visible while a user of the vehicle interacts with different, other systems of the vehicle from the same, common display module.

The vehicle based data processing system can generate the navigation application such that includes a plurality of points of interest corresponding to the geographical location of the vehicle. The plurality of points of interest can include links to services, products, or other forms of offers from third party vendors corresponding to the plurality of points of interest. The vehicle based data processing system can generate the navigation application along with interfaces to different systems or applications of the vehicle. Thus, the consolidated interface can allow a user of the vehicle to interact with the navigation application and different systems or applications of the vehicle from a single consolidated system. The consolidated interface can consolidate or combine different processors and logic from multiple systems or components of a vehicle into a single system to more efficiently manage computer resources of the respective vehicle. The consolidated interface can couple with a single display module having multiple displays to consolidate hardware resources of the respective vehicle. For example, instead of multiple different displays, each of which provide content corresponding to different systems of the vehicle, the consolidated interfaces as described herein can provide a single system with a single display module to provide content from each of the different systems of the vehicle and the navigation application. Thus, separate displays, panels, processors, or logic can be eliminated or reduced to more efficiently manage the computer resources (e.g., software, hardware) of the respective vehicle. This can reduce vehicle weight and increase vehicle range per charge or fuel cycle. The consolidated interface can improve computer resource allocation by eliminating or reducing the amount of separate and distinct processors and hardware elements for vehicle systems that may be used sparingly. Thus, conserving and efficiently allocating computer resources of the respective vehicle through the consolidated interface. The consolidated interface can include a touch screen display to provide an input device via the display module in a common location such that the user of the vehicle can interact with the different systems and navigation application of the vehicle from a single vantage point. This can help to conserve computer resources, and may avoid or eliminate different systems of the vehicle each having independent input devices for a user of the vehicle to interact with the respective system of the vehicle.

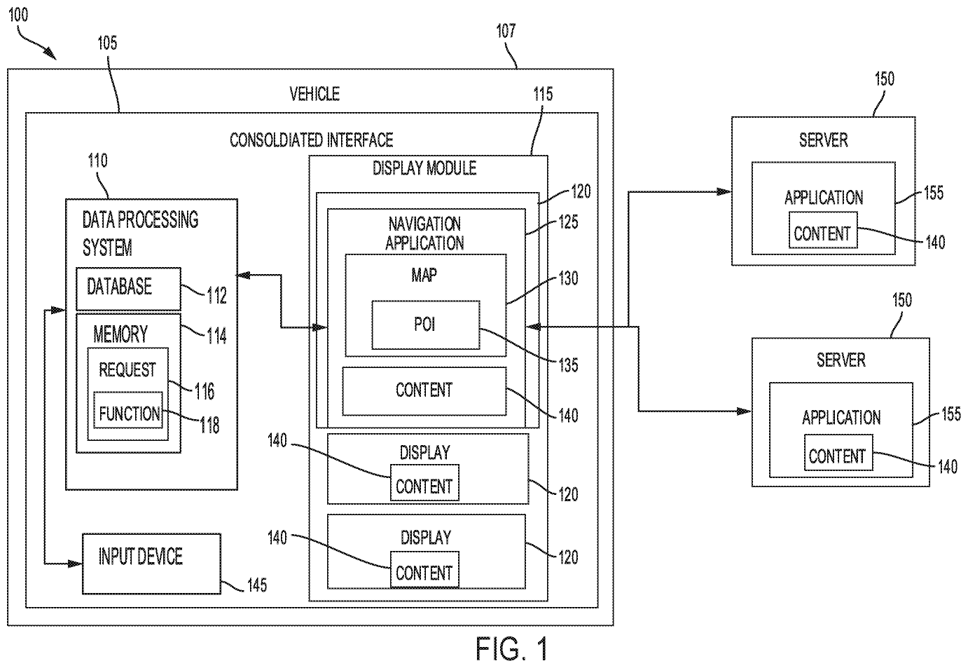

FIG. 1, among others, depicts a view 100 of a block diagram of a consolidated vehicle navigation and instrument system 105 (“consolidated interface”) for a vehicle 107. The vehicle 107 can include a configuration, arrangement or network of electrical, electronic, mechanical or electromechanical devices within a vehicle of any type. The vehicle 107 can include automobiles, cars, trucks, passenger vehicles, industrial vehicles, motorcycles, and other transport vehicles. The vehicle 107 can include electric vehicles, electric automobiles, cars, motorcycles, scooters, passenger vehicles, passenger or commercial trucks, and other vehicles such as sea or air transport vehicles, planes, helicopters, submarines, boats, or drones. The vehicle 107 can be fully autonomous, partially autonomous, or unmanned. Thus, the vehicle 107 can include an autonomous, semi-autonomous, or non-autonomous human operated vehicle. The vehicle 107 can include a hybrid vehicle that operates from on-board electric sources and from gasoline or other power sources. The vehicle 107 can include an electric vehicle (EVs), hybrid vehicle, fossil fuel vehicle, a car, a truck, motorcycles, scooters, passenger vehicles, passenger or commercial trucks, and other vehicles such as sea or air transport vehicles, planes, helicopters, submarines, boats, or drones. The EV s can include electric automobiles, cars, motorcycles, scooters, passenger vehicles, passenger or commercial trucks, and other vehicles such as sea or air transport vehicles, planes, helicopters, submarines, boats, or drones. EVs can be fully autonomous, partially autonomous, or unmanned.

The consolidated interface 105 can couple multiple different systems, including a navigation application 125, or other applications executing within, executing on the vehicle 107 or external to the vehicle 107 (e.g., third party servers, servers 150) within a single system to conserve and more efficiently allocate computer resources of the respective vehicle 107 through the consolidated interface 105. The consolidated interface 105 can include a display module 115 having a plurality of displays 120 to provide a visual interface window for a user of the vehicle 107 to interact with the different systems or applications of the vehicle 107 from the single consolidated interface 105. For example, the user can be provided access to the navigation application 125, a climate control menu, an entertainment menu, an autonomous drive menu, or a phone menu through different displays of the display module 115. Thus, the consolidated interface 105 as described herein can reduce or eliminate the need for any specific button layout, independent hardware, independent software for each of the different systems of the vehicle 107 as they can be provided within the single consolidated interface 105 and share a common vehicle based data processing system 110. The consolidated interface 105 can provide a consistent and easily accessible control interface for any context the user may want to interface with in the vehicle 107 directly from, for example but not limited to, a console of the vehicle 107.

The consolidated interface 105 can include a vehicle based data processing system (e.g., DPS) 110. The vehicle based data processing system 110 can generate control signals to modify content for the navigation application 125 or content displayed within each of the displays 120 of the display module 115. For example, the vehicle based data processing system 110 can receive an input from a user of the vehicle 107 and generate control signals, responsive to the input, to modify content for the navigation application 125 or content displayed within each of the displays 120. The vehicle based data processing system 110 can include a database 112 and a memory 114. The vehicle based data processing system 110 can be implemented using hardware or a combination of software and hardware. For example, each component of the vehicle based data processing system 110 can include logical circuity (e.g., a central processing unit or CPU) that responses to and processes instructions fetched from a memory unit (e.g., memory 114). Each component of the vehicle based data processing system 110 can include or use a microprocessor or a multi-core processor. A multi-core processor can include two or more processing units on a single computing component. Each component of the vehicle based data processing system 110 can be based on any of these processors, or any other processor capable of operating as described herein. Each processor can utilize instruction level parallelism, thread level parallelism, different levels of cache, etc.

For example, the vehicle based data processing system 110 can include at least one logic device such as a computing device or server having at least one processor to communicate via a network with one or more systems of the vehicle 107. The components and elements (e.g., database 112, memory 114) of the vehicle based data processing system 110 can be separate components, a single component, or part of the vehicle based data processing system 110. For example, the database 112 and the memory 114) can include combinations of hardware and software, such as one or more processors configured to initiate stop commands, initiate motion commands, and transmit or receive timing data, for example.

The database 112 can include a structured set of data stored for the vehicle based data processing system 110. The database 112 can couple with the memory 114 to store and retrieve data, such as, requests 116, functions 118, a map (e.g., map 130), points of interest (e.g., points of interest 135), display properties (e.g., displays 120), contact inputs, touch inputs, audio inputs, geographical information, vehicle information, command instructions, vehicle status information, environmental information within or external to the vehicle, road status or road condition information, vehicle location information or other information during execution of instructions by the vehicle based data processing system 110. The memory 114 can include a random access memory (RAM) or other dynamic storage device, coupled with the vehicle based data processing system 110 for storing information, and instructions to be executed by the vehicle based data processing system 110. The memory 114 can be used for storing requests 116, functions 118, one or more maps (e.g., map 130), points of interest (e.g., points of interest 135), display properties (e.g., displays 120), contact inputs, touch inputs, audio inputs, geographical information, vehicle information, command instructions, vehicle status information, environmental information within or external to the vehicle, road status or road condition information, vehicle location information or other information during execution of instructions by the vehicle based data processing system 110. The memory 114 can include at least one read only memory (ROM) or other static storage device coupled with the vehicle based data processing system 110 for storing static information and instructions for the vehicle based data processing system 110. The memory 114 can include a storage device, such as a solid state device, magnetic disk or optical disk, coupled with the vehicle based data processing system 110 to persistently store information and instructions.

The consolidated interface 105 can include a display module 115 having a plurality of displays 120 to provide content 140 corresponding to different systems of the vehicle 107 (e.g., climate control menu, entertainment menu, navigation menu). Each of the displays 120 can display at least one content item 140. At least one of display 120 of the plurality of displays 120 can be assigned to provide or otherwise display a navigation application 125 generated by the vehicle based data processing system 110. For example, at least one display 120 of the plurality of displays 120 can be dedicated to display the navigation application 125 when the vehicle 107 is active otherwise turned on, such that the navigation application 125 is always visible to a user of the vehicle 107 when the vehicle 107 is active otherwise turned on. The navigation application 125 can include a map 130 having a plurality of points of interest 135. The map 130 can include a data structure containing a diagrammatic representation of an area of land, sea or a combination of land and sea showing physical features, such as, cities, towns, roads, buildings, and environmental objects (e.g., trees, hills, waterways). The map 130 can correspond to a geographical location of the vehicle 107 or a desired geographical location of the vehicle 107. The map 130 can be generated by the vehicle based data processing system 110. The map 130 can include at least one point of interest 135. The map 130 can include a plurality of points of interest 135. The points of interest 135 can correspond to different locations or features within a geographical location of the vehicle 107 or a desired geographical location of the vehicle 107. For example, points of interest 135 can include destinations, home address, schools, stores, offices, shopping centers, coffee shops, grocery stores, or environmental destinations (e.g., park, lake, mountain). The points of interest 135 can include data structures saved in a database (e.g., database 112) of the consolidated interface 105 or a database separate from but communicatively coupled with the consolidated interface 105. For example, the points of interest 135 can include a data structure having a latitude value and a longitude value for the respective point of interest 135. The points of interest 135 can include a data structure having a telephone number, a web address, email address or other forms of contact information for the respective point of interest 135. The points of interest 135 can include a data structure having a listing of products offered by the respective point of interest 135, a listing of services offered by the respective point of interest 135, advertisements or offers provided by the respective point of interest 135, or other forms of data corresponding to the respective point of interest 135. The points of interest 135 can be linked with or include at least one link to an external server (e.g., servers 150) to request to retrieve content corresponding to the respective point of interest 135. For example, the vehicle based data processing system 110 can generate at least one hyperlink for each of the plurality of points of interest 135 provided within the map 130. The vehicle based data processing system 110 can generate the plurality of points of interest 135 such that each of the points of interest 135 include a hyperlink or are tagged with a hyperlink to redirect a user of the vehicle from the navigation application 125 to a server (e.g., servers 150) corresponding to the respective point of interest 135.

The content 140 can include data structures stored in a database (e.g., database 112) of the consolidated interface 105 or a database separate from but communicatively coupled with the consolidated interface 105. The content 140 can include, for example, at least one of: a climate control menu, an entertainment menu, an autonomous drive menu, a navigation menu, and a phone menu. The content 140 can correspond to any system, component or element of the vehicle 107 or any system, component or element coupled with the vehicle 107 (e.g., cell phone, computing device, electronic key). The display module 115 can provide a visual output or an audio output from the vehicle based data processing system 110, the vehicle 107 or other forms of computing device content to a user of the vehicle 107 through the plurality of displays 120. For example, the display module 115 can provide a visual feedback output from the vehicle based data processing system 110 to a user of the vehicle 107 through the plurality of displays 120. The displays 120 can include an electronic device for the visual presentation of data, such as but not limited to, menu items 125. The displays 120 (e.g., display windows) can include an interface, a screen, a digital window, or display device to provide a visual display to a user of the vehicle 107. The displays 120 can correspond to portions of the display module 115 generated by the vehicle based data processing system 110. The display module 115 and each of the plurality of displays 120 can include a touch screen. For example, the display module 115 and each of the plurality of displays 120 can receive a contact or touch input via a screen of the respective display 120 and generate a signal corresponding to the contact input. Thus, display module 115 and each of the plurality of displays 120 can provide an interface for a user to interact with through contact.

The dimensions of the displays 120 can vary based at least in part on a location within a vehicle 107 that the displays 120 are disposed or provided. The vehicle based data processing system 110 can generate the displays 120 having varying dimensions or the same dimensions to fit or position within the component of the vehicle the display module 115 is disposed within (e.g., console, dashboard). For example, the vehicle based data processing system 110 can generate the display module 115 having five displays 120 of varying dimensions. The vehicle based data processing system 110 can vary the dimensions based in part on the dimensions for a display 120 dedicated to provide the navigation application 125. For example, the vehicle based data processing system 110 can generate the display module 115 having at least one display 120 providing the navigation application 125 having smaller dimensions. The vehicle based data processing system 110 can generate the display module 115 having at least one display 120 providing the navigation application 125 having larger dimensions. In the example with at least one display 120 providing the navigation application 125 having smaller or reduced dimensions, a first display 120 can have a height or length in a range from 1 inch to 4 inches (e.g., 1.7 inches) and a width in a range from 7 inches to 12 inches (e.g., 9 inches). A second display 120 can have a height or length in a range from 0.5 inches to 4 inches (e.g., 0.75 inches) and a width in a range from 7 inches to 12 inches (e.g., 9 inches). A third display 120 dedicated to the navigation application 125 can have a height or length in a range from 2 inches to 5 inches (e.g., 3.5 inches) and a width in a range from 7 inches to 12 inches (e.g., 9 inches). A fourth display 120 can have a height or length in a range from 3 inches to 6 inches (e.g., 4.55 inches) and a width in a range from 7 inches to 12 inches (e.g., 9 inches). A fifth display 120 can have a height or length in a range from 3 inches to 5 inches (e.g., 4 inches) and a width in a range from 7 inches to 12 inches (e.g., 9 inches). In the example with at least one display 120 providing the navigation application 125 having larger or increased dimensions, a first display 120 can have a height or length in a range from 1 inch to 4 inches (e.g., 1.7 inches) and a width in a range from 7 inches to 12 inches (e.g., 9 inches). A second display 120 can have a height or length in a range from 0.5 inches to 4 inches (e.g., 0.75 inches) and a width in a range from 7 inches to 12 inches (e.g., 9 inches). A third display 120 dedicated to the navigation application 125 can have a height or length in a range from 4 inches to 8 inches (e.g., 6.35 inches) and a width in a range from 7 inches to 12 inches (e.g., 9 inches). A fourth display 120 can have a height or length in a range from 1 inch to 3 inches (e.g., 1.7 inches) and a width in a range from 7 inches to 12 inches (e.g., 9 inches). A fifth display 120 can have a height or length in a range from 3 inches to 5 inches (e.g., 4 inches) and a width in a range from 7 inches to 12 inches (e.g., 9 inches). The vehicle based data processing system 110 can generate the displays 120 within the display module 115 having varying heights or lengths and the same width. The vehicle based data processing system 110 can generate the displays 120 within the display module 115 having the same height or length and varying widths. The vehicle based data processing system 110 can generate the displays 120 within the display module 115 having varying heights or lengths and varying widths.

Each of the displays 120 can have the same dimensions. One or more of the displays 120 can have different (e.g., greater, less than) dimensions that one or more other displays 120. The dimensions of the displays 120 can be dynamically modified by the vehicle based data processing system 110. For example, the vehicle based data processing system 110 can generate the displays 120 for the display module 115. The vehicle based data processing system 110 can determine a number of displays 120 to provide within the display module 115 based in part on the dimensions of the display module 115 or a user of the vehicle. The vehicle based data processing system 110 can determine dimensions (e.g., diameter, radius, length, width) of the displays 120. The vehicle based data processing system 110 can determine a number of pixels within the display module 115 to allocate to each of the displays 120. The dimensions or pixel value assigned to a display 120 can be selected based at least in part on a content 140 to be provided within the respective display 120. The vehicle based data processing system 110 can determine a position for each of the displays 120 within the display module 115. The vehicle based data processing system 110 can determine which display 120 can be assigned to the navigation application 125 and which displays 120 can be provide other systems of the windows can be an offset display 120. The vehicle based data processing system 110 can generate and assign content 140 to each of the displays 120. The vehicle based data processing system 110 can positon and relocate the content 140 between each of the displays 120, for example, responsive to a user of the vehicle 107 or responsive to an input received through one of the displays 120. For example, the vehicle based data processing system 110 can relocate or move the navigation application 125 from a first display 120 of the plurality of displays 120 to a second, different display 120 of the plurality of displays 120. The display module 115 can be disposed within or provided within various components of the vehicle 107. For example, but not limited to, the display module 115 and the plurality of displays 120 can be disposed within or provided within a dashboard, a console, a steering wheel, or a seat (e.g., head rest, back portion) of the vehicle 107. The display module 115 can include two or more displays 120. The display module 115 can include a single display 120. The display module 115 can provide a visual or audio output from the vehicle based data processing system 110, the vehicle 107 or other forms of computing device content to a user of the vehicle 107.

The consolidated interface 105 can include or couple with at least one input device 145. The input device 145 can include a device, a human interface device, a computing device or computing element to receive and provide data and control signals to the vehicle based data processing system 110. The input device 145 can generate the control signal responsive to, but not limited to, a physical motion, mechanical motion, or audio input. For example, the input device 145 can generate a control signal responsive to contact (e.g., physical contact) with a surface of the input device 145. The input device 145 can generate the control signal responsive to, but not limited to, a touching, a pressing, a swipe motion or other forms of contact with the surface of the input device 145. The contact can include discrete contact or continuous contact. The input device 145 can include a keypad, a layout of buttons or group of buttons. For example, the buttons can generate a signal responsive to at least one of a contact input, a physical motion input, a mechanical motion input, and an audio input. The input device 145 can include two or more buttons. The input device 145 can include a single button. The buttons can include mechanical buttons (e.g., spring based buttons), digital buttons or virtual buttons. The input device 145 can be provided on or couple with different portions of the vehicle 107. For example, the input device 145 can be provided on or couple with a steering wheel, a console or a dashboard of the vehicle 107.

The consolidated interface 105 can couple with at least one server 150 that hosts or provides at least one application 155. The servers 150 can include remote servers or third party servers executing external to the vehicle 107 or the vehicle based data processing system 110. For example, the servers 150 may include an application delivery system for delivering an application 155, a computing environment, and/or data files to the vehicle based data processing system 110. The servers 150 can include HTTP servers or application servers. The servers 150 can correspond to vendors, stores, destinations, home address, schools, offices, shopping centers, coffee shops, grocery stores, or environmental destinations (e.g., park, lake, mountain). For example, each of the points of interest 135 displayed within the map 130 can be linked with at least one server 150 to retrieve content 140 from or corresponding to the respective point of interest 135. For example, a point of interest 135 may include a coffee shop. The coffee shop point of interest 135 can be linked, for example, using a hyperlink, with a web address of the corresponding coffee shop hosted by at least one server 150. The vehicle based data processing system 110 can request or retrieve content 140 for the different points of interest 135 displayed within the map 130 of the navigation application using the servers 150. For example, responsive to an input from a user of the vehicle 107, the vehicle based data processing system 110 can generate a request 116 for content 140 from a server 150 corresponding to or linked with (e.g., via a hyperlink provided within the map 130) a point of interest 135 that the user interacted with through the display module 115. The vehicle based data processing system 110 can generate a function 118 to include with the request 116 to the third party server. The function 118 can cause the third party application to generate content 140 corresponding to the request 116 or retrieve content 140 corresponding to the request 116. For example, the function 118 can include a set of instructions to be executed by the third party server to generate or retrieve content 140 corresponding to a point of interest 135. In the coffee shop point of interest 135 example, the function 118 can include a set of instructions to cause the third party server to retrieve menu data and price data for coffee supplied by the respective coffee shop. The vehicle based data processing system 110 can receive the content 140 (e.g., coffee menu with coffee prices) and display the content 140 within the map 130 of the navigation application 125. For example, the vehicle based data processing system 110 can overlay the content 140 (e.g., overlay advertisement, overlay display) over a portion of the map 130 of the navigation application 125 such that the map 130 remains visible within the vehicle 130. The content 140 generated by the servers 150 can include, for example, a telephone number, a web address, email address or other forms of contact information for the respective point of interest 135. The content 140 generated by the servers 150 can include, for example, a listing of products offered by the respective point of interest 135, a listing of services offered by the respective point of interest 135, advertisements or offers provided by the respective point of interest 135, or other forms of data corresponding to the respective point of interest 135.

The servers 150 can provide or host at least one application 155. The applications 155 can correspond to a point of service tool for a point of interest 135. For example, the applications 155 can include a home page or web content corresponding to a point of interest 135. The applications 155 may include web content, HTTP content or resources provided by or hosted by the servers 150. For example, the applications 155 may include network applications that are served from and/or hosted on the servers 150. The applications 155 can include an application hosted on at least one server 150 accessed by the vehicle based data processing system 110 via a network. The applications 155 can include, but not limited to, a web application, a desktop application, remote-hosted application, a virtual application, a mobile application, an HDX application, a local application, or a native application (e.g., native to the vehicle based data processing system 110 or vehicle 107). The vehicle based data processing system 110 and the servers 150 can be communicatively coupled through a network, such as but not limited to, a public network, a wide area network (WAN) or the Internet. The network may be a private network such as a local area network (LAN) or a company Intranet. The network may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

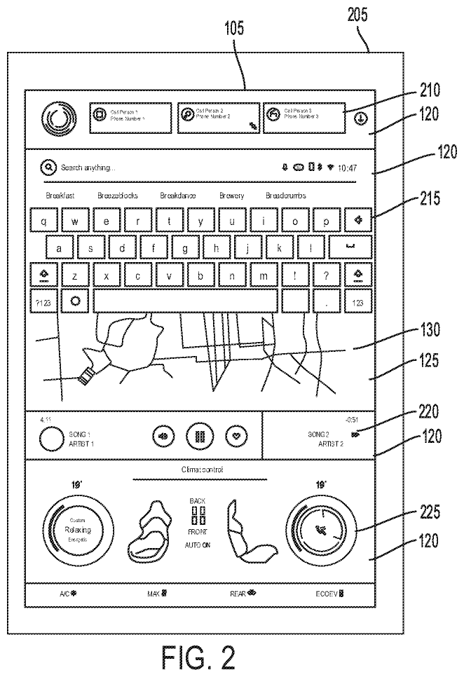

FIG. 2, among others, depicts a consolidated interface 105 provided within a console 205 of a vehicle 107. The consolidated interface 105 can include a plurality of windows 120 to provide menus or applications corresponding to different systems of the vehicle 107 through a single consolidated display. Thus, the consolidated interface 105 can combine processing power of multiple systems into a single system to efficiently manage the allocation of computer resources within the vehicle 107. For example, the consolidated interface 105 can include a first display 120 providing a phone menu 210. The consolidated interface 105 can include a second display 120 providing a search menu 215. The consolidated interface 105 can include a third display 120 dedicated to a navigation application 125 having a map 130. For example, the third display 120 can display the map 130 of the navigation application 125 at all times when the vehicle 107 is active, turned on or otherwise in use. The consolidated interface 105 can include a fourth display 120 providing an entertainment menu 220. The consolidated interface 105 can include a fifth display 120 providing a climate control menu 225.

The vehicle based data processing system 110 can generate a standard display layout for the consolidated interface 105. For example, when the vehicle 170 is turned on, the vehicle based data processing system 110 can initially display a standard display layout having a plurality of displays 120 and at least one display 120 dedicated to the navigation application 125. The standard display layout can correspond to a factory setting or setting selected by a user or owner of the vehicle 107. The vehicle based data processing system 110 can generate a custom display layout or modify display layout properties responsive to inputs or interactions from a user of the vehicle 107. For example, the vehicle based data processing system 110 can generate custom display layouts that are unique to each user of the vehicle 107. The custom display layout settings can be stored in the memory 114 of the vehicle based data processing system. The vehicle based data processing system 110 can identify a user of the vehicle 107 when the vehicle is turned on and identify a custom display layout for the user of the vehicle 107. The vehicle based data processing system 110 can update or modify the custom display layout responsive to user inputs or user interactions with the respective custom display layout. For example, the vehicle based data processing system 110 can monitor which display 120 the user prefers to the navigation application 125 provided within, for the third display 120. The vehicle based data processing system 110 can update a user profile of the respective user to reflect that the user prefers to have the navigation application 120 provided within the third display 120. The vehicle based data processing system 110 can continually update or dynamically modify user profiles to reflect user inputs or user interactions with a custom display layout corresponding to the user.

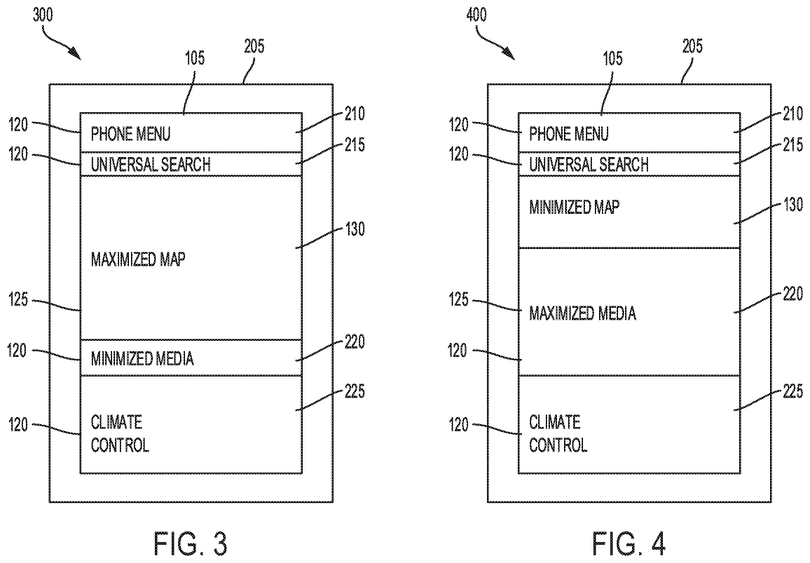

FIG. 3, among others, depicts a display layout 300 of a consolidated interface 105 provided within a console 205 of a vehicle 107. The display layout 300 can include a first display 120 providing a phone menu 210 having a first set of dimensions. The display layout 300 can include a second display 120 providing a search menu 215 having a first set of dimensions. The display layout 300 can include a third display 120 dedicated to a navigation application 125 having a map 130 and a first set of dimensions. The display layout 300 can include a fourth display 120 providing an entertainment menu 220 having a first set of dimensions. The display layout 300 can include a fifth display 120 providing a climate control menu 225 having a first set of dimensions. The vehicle based data processing system 110 can generate the dimensions for each of the displays 120 based on a standard display layout settings or a custom display layout settings corresponding to a user of the vehicle 107. The dimensions can correspond to a length value, width value, diameter value, or a combination of a length value and a width value. The dimensions can correspond to a pixel value assigned or allocated to the displays 120 by the vehicle based data processing system. The vehicle based data processing system 110 can determine the dimensions based in part on the dimensions of the console 205 the consolidated interface 105 is provided within. For example, the vehicle based data processing system 110 can generate each of the displays 120 such that the displays 120 are visible or at least partially visible within the vehicle 107 with respect to a viewpoint of a user of the vehicle 107. The vehicle based data processing system 110 can generate a set of instructions for the display module 115 corresponding to each display 120 to generate each of the displays 120 having the determined dimensions or pixel values. For example, the instructions can include the dimensions or pixel values for each of the displays 120 to be generated. The vehicle based data processing system 110 can generate each of the displays 120 having the same visibility (e.g., same dimensions, same pixel value). The vehicle based data processing system 110 can generate one or more of the displays 120 having a different visibility (e.g., same dimensions, same pixel value) from one or more other displays 120. The display module 115 can receive the set of instructions from the vehicle based data processing system 110 and generate or provide each of the displays 120 using the instructions having the dimensions or pixel values for each of the displays 120 to be generated.

FIG. 4, among others, depicts a display layout 400 of a consolidated interface 105 provided within a console 205 of a vehicle 107. In FIG. 4, the dimensions of the third display 120 dedicated to the navigation application 125 and the fourth display 120 provided in the entertainment menu 220 have been modified. For example, the dimensions of the third display 120 have been reduced to make the map 130 of the navigation application 125 smaller as compared to the display layout 300 of FIG. 3. The dimensions of the fourth display 120 have been increased to make the entertainment menu 220 larger as compared to the display layout 300 of FIG. 3. The vehicle based data processing system 110 can generate a set of instructions to modify the dimensions of a display 120. For example, the vehicle based data processing system 110 can generate a set of instructions to reduce the size of the map 130. The instructions to reduce the size of the third display 120 (or any display 120) can include a new set of dimensions that include smaller dimensions (e.g., smaller width, smaller length, smaller diameter) as compared to the dimensions the third display 120 was assigned in the display layout 300 of FIG. 3. The instructions to reduce the size of the third display 120 (or any display 120) can include a new pixel value that includes less pixels than the pixel value assigned to the third display 120 in the display layout 300 of FIG. 3. The vehicle based data processing system 110 can reduce the size of the map 130 in the third display 120 by various amounts based in part on the size of the other displays 120 within the display module 115. For example, the vehicle based data processing system 110 can reduce the size of the map 130 in the third display 120 by 10%. The vehicle based data processing system 110 can reduce the size of the map 130 in the third display 120 by 50%. The vehicle based data processing system 110 can remove the third display 120 from the display module 115 and thus, reduce the size of the map 130 in the third display 120 by 100%. The vehicle based data processing system 110 can reduce the size of a display 120 in the display module 115 in a range from 5% to 100%.

The vehicle based data processing system 110 can generate a set of instructions to increase the size of the fourth display 120. The instructions to increase the size of the fourth display 120 (or any display 120) can include a new set of dimensions that include larger dimensions (e.g., greater width, greater length, greater diameter) as compared to the dimensions the fourth display 120 was assigned in the display layout 300 of FIG. 3. The instructions to increase the size of the fourth display 120 (or any display 120) can include a new pixel value that includes more pixels than the pixel value assigned to the fourth display 120 in the display layout 300 of FIG. 3. The vehicle based data processing system 110 can increase the size of the fourth display 120 by various amounts based in part on the size of the other displays 120 within the display module 115. For example, the vehicle based data processing system 110 can increase the size of the fourth display 120 by 10%. The vehicle based data processing system 110 can increase the size of the fourth display 120 by 50%. The vehicle based data processing system 110 can add the fourth display 120 to the display module 115 and thus, increase the size of the fourth display 120 by 100%. The vehicle based data processing system 110 can increase the size of a display 120 in the display module 115 in a range from 5% to 100%.

The vehicle based data processing system 110 can modify the dimensions or pixel value for one or more displays 120 responsive to an input or interaction from a user of the vehicle 107. The interaction can include a new user entering the vehicle 107, a touch input through at least one display 120, an input through an input device 145 of the vehicle 107 or a voice command. For example, in FIG. 4, the display layout 400 can include the first display 120 providing a phone menu 210 having the first set of dimensions from the display layout 300 of FIG. 3. The display layout 400 can include the second display 120 providing a search menu 215 having the first set of dimensions from the display layout 300 of FIG. 3. The display layout 400 can include the third display 120 dedicated to a navigation application 125 having a map 130 and a second set of dimensions. The second set of dimensions of the third display 120 can be different from the first set of dimensions of the third display 120 from the display layout 300 of FIG. 3. The display layout 400 can include the fourth display 120 providing an entertainment menu 220 having a second set of dimensions. The second set of dimensions of the fourth display 120 can be different from the first set of dimensions of the fourth display 120 from the display layout 300 of FIG. 3. The display layout 400 can include the fifth display 120 providing the climate control menu 225 having the first set of dimensions from the display layout 300 of FIG. 3. Thus, the dimensions of the third display 120 and the fourth display 120 can be modified by the vehicle based data processing system 110. The vehicle based data processing system 110 can modify the dimensions by decreasing a size of the third display 120 providing the navigation application 125 and increasing a size of the fourth display 120 providing the entertainment menu 220. For example, the vehicle based data processing system 110, responsive to an input or interaction, can generate instructions to decrease the size of the third display 120 providing the navigation application 125 and increase the size of the fourth display 120 providing the entertainment menu 220. The vehicle based data processing system 110, responsive to an input or interaction, can generate instructions to decrease the pixel value allocated to the third display 120 providing the navigation application 125 and increase the pixel value allocated to the fourth display 120 providing the entertainment menu 220. The vehicle based data processing system 110 can apply the instructions to the third window 120 and the fourth window 120. The vehicle based data processing system 110 can store the instructions in the memory 114 for later use or to update a user profile of a user requested the modification to the display layout 400.

The vehicle based data processing system 110 can modify a position or location of one or more displays 120 of the display module 115 responsive to an input or interaction. For example, the vehicle based data processing system 110, responsive to an input or interaction, can generate instructions to relocate the navigation application 125 from the third display 120 to the first display 120. The vehicle based data processing system 110, responsive to an input or interaction, can generate instructions to relocate the content 140, here the phone menu 210 provided within the first display 120, from the first display 120 to the third display 120. The vehicle based data processing system 110 can apply the instructions to first display 120 and the third display 120 to relocate the navigation application 125 from the third display 120 to the first display 120 and relocate the phone menu 210 from the first display 120 to the third display 120.

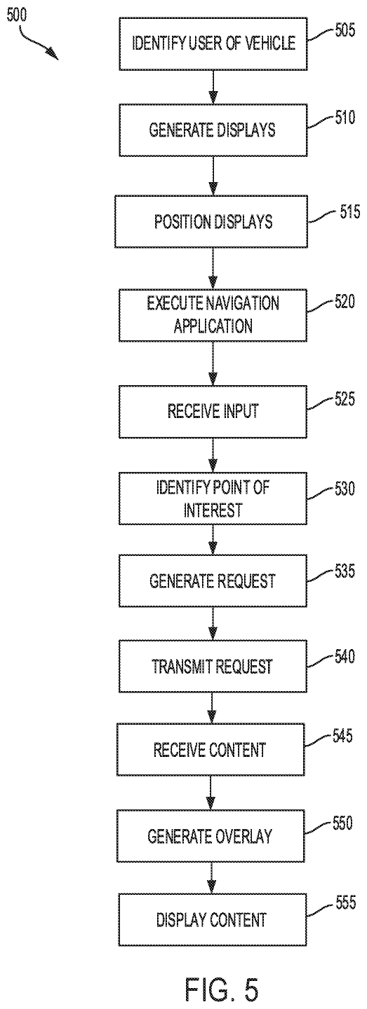

FIG. 5, among others, depicts a method 500 for consolidated navigation application within a vehicle 107. The method 500 can include identifying a user of the vehicle 107 (ACT 505). The vehicle 107 can include a consolidated interface 105 having a vehicle based data processing system 110. The vehicle based data processing system 110 can determine at least one user of the vehicle 107. For example, responsive to activating or turning on the vehicle or activating the consolidated interface 105, the vehicle based data processing system 110 can determine how many users are in the vehicle 107 and properties of the users (or user) in the vehicle 107. A user can refer to a driver or passenger in the vehicle 107. The vehicle based data processing system 110 can couple with one or more sensors within the vehicle to determine how many users are in the vehicle 107. For example, the seats in the vehicle can include sensors and the sensors can transmit a signal to the vehicle based data processing system 110 to indicate when a user is sitting in or on the respective seat. The vehicle based data processing system 110 can use the seat data to identify whether the user is a driver or passenger of the vehicle 107 or a combination of a driver and one or more passengers of the vehicle 107.

The vehicle based data processing system 110 can detect the presence or couple with one or more devices of a user of the vehicle 107 to detect the user of the vehicle 107. For example, the vehicle based data processing system 110 can detect the presence of a cell phone or hand held computing device and identify a user of the cell phone or hand held computing device. The vehicle based data processing system 110 can detect the presence of a key, electronic key, or key fob of the vehicle 107. The vehicle based data processing system 110 can use the device data to identify the corresponding user of the device. For example, the vehicle based data processing system 110 can receive user data from the device when the device couples with the consolidated interface 105. The vehicle based data processing system 110 can store user profiles and use the device data to identify the user of the respective device.

The method 500 can include generating displays 120 (ACT 510). For example, the method 500 can include providing, by a vehicle based data processing system 110, a plurality of displays 120 of a display module 115 visible within a vehicle 107. The display module 115 can communicatively couple with the vehicle based data processing system 110 to receive signals or transmit signals. The vehicle based data processing system 110 can generate a single display 120 for the display module 115. The vehicle based data processing system 110 can generate two or more displays 120 for the display module 115. The vehicle based data processing system 110 can determine a number of displays 120 based in part on the identified user of the vehicle 107. For example, the user may have a preferred display layout stored in the memory 114 of the vehicle based data processing system 110. Responsive to identifying the user of the vehicle 107, the vehicle based data processing system 110 can retrieve the preferred display layout for the user and generate a number of display 120 corresponding to the preferred display layout. The vehicle based data processing system 110 can determine a number of displays 120 based in part on a standard display layout. For example, the display module 115 can include a standard display layout having a predetermined number of displays 120 that the vehicle based data processing system 110 generates when the vehicle 107 is activated or turned on.

The vehicle based data processing system 110 can generate the displays 120 such that each of the displays 120 can be visible or at least partially visible within the vehicle 107 with respect to a viewpoint of a user of the vehicle 107. For example, the vehicle based data processing system 110 can generate each of the displays 120 having the same visibility (e.g., same dimensions, same pixel value). The vehicle based data processing system 110 can generate one or more of the displays 120 having a different visibility (e.g., same dimensions, same pixel value) from one or more other displays 120. For example, the vehicle based data processing system 110 can generate a first display 120 having a greater visibility within the vehicle 107 than the other displays 120 of the plurality of displays 120 of the display module 115. For example, the first display 120 can have a larger diameter or be assigned more pixels than the other displays 120 of the plurality of displays 120 of the display module 115.

The method 500 can include generating content 140 (ACT 515). For example, the method 500 can include generating, by the vehicle based data processing system 110, content 140 for the plurality of displays 120. The vehicle based data processing system 110 can generate the content 140 based in part of one or more users of the vehicle 107, a time of day, a location of the vehicle 107, or a device coupled with the vehicle based data processing system 110. For example, the content 140 can correspond to, for example, a climate control menu, an entertainment menu, an autonomous drive menu, a navigation menu (e.g., navigation application 125), or a phone menu. The vehicle based data processing system 110 can display the content 140 within the plurality of displays 120 for the user or users of the vehicle 107 to interact with the content 140. Each of the displays 120 can display at least one content item 140.

The vehicle based data processing system 110 can generate the content 140 based in part on a relevance to the user or users of the vehicle 107. For example, the vehicle based data processing system 110 can identify and select the most relevant or most important content 140 to display through the displays 120 of the consolidated interface 105. The vehicle based data processing system 110 can determine the relevance based at least in part on a frequency of use, time of day or properties of a user profile corresponding to the one or more users in the vehicle 107. For example, the vehicle based data processing system 110 can extract data from the user profile including content 140 that the corresponding user interacts with the most or has previously interacted with. The user profile can include content 140 ranked within the user profile based in part on frequency of use. The vehicle based data processing system 110 can extract the highest ranked or most used content 140 from the user profile and display the content 140 within one or more displays 120.

The method 500 can include executing a navigation application 125 (ACT 520). For example, the method 500 can include executing, by the vehicle based data processing unit 110, a navigation application 125 within a first display 120 of the plurality of displays 120. The navigation application 125 can provide points of interest 135 corresponding to a location of the vehicle 107. The navigation application 125 can include a map 130 with the points of interest 135 provided within the map 130. The vehicle based data processing system 110 can select at least one display 120 of the plurality of displays 120 to be a dedicated display 120 for the navigation application 125. For example, the vehicle based data processing system 110 can select one display 120 (e.g., a first display 120) to continuously display the navigation application 125 when the vehicle 107 is active, turned on or when the vehicle 107 is in operation. The vehicle based data processing system 110 can display the navigation application 125 such that the navigation application 125, including the map 130 having one or more points of interest 135, is always visible within the vehicle 107 when the vehicle 107 is active, turned on or when the vehicle 107 is in operation.

The vehicle based data processing system 110 can determine dimensions (e.g., length, width, diameter) of the display 120 dedicated to the navigation application 135. The dimensions can be selected based in part on the map 130 to be generated within the navigation application 125. For example, the dimensions can be selected based in part on a size of a geographical area to be represented by the map 130. The dimensions can be selected based in part on a number of points of interest 135 to be provided within the map 130. The vehicle based data processing system 110 can determine a number of pixels (e.g., pixel value) to be allocated or assigned to the display 120 dedicated to the navigation application 135. The pixel value can be selected based in part on the map 130 to be generated within the navigation application 125. For example, the pixel value can be selected based in part on a size of a geographical area to be represented by the map 130. The pixel value can be selected based in part on a number of points of interest 135 to be provided within the map 130. The vehicle based data processing system 110 can dynamically modify the dimensions or pixel value for the display 120 dedicated to the navigation application 135. For example, responsive to an interaction or input from a user of the vehicle, the vehicle based data processing system 110 can dynamically increase the size or dynamically increase the pixel value for the display 120 dedicated to the navigation application 135. Responsive to an interaction or input from a user of the vehicle, the vehicle based data processing system 110 can dynamically decrease the size or dynamically decrease the pixel value for the display 120 dedicated to the navigation application 135. For example, the vehicle based data processing system 110 can modify a size of the display 120 providing the navigation application 125 responsive to an interaction or the input.

The vehicle based data processing system 110 can generate a first map 130 within the navigation application 125. The first map 130 can correspond to a current geographical location of the vehicle 107. The vehicle based data processing system 110 can generate the first map 130 having a first subset of points of interest 135. For example, the first subset can correspond to the location of the vehicle 107 and include points of interest within a geographical range of the location of the vehicle 107. The vehicle based data processing system 110 can modify one or more points of interest 135 in the first subset of points of interest 135 within the first map 130 responsive to a change of the location of the vehicle 107. The vehicle based data processing system 110 can identify and select the most relevant points of interest 135 for the first map 130 based at least in part on a frequency of use, time of day or properties of a user profile corresponding to the one or more users in the vehicle 107. For example, the vehicle based data processing system 110 can extract data from the user profile including points of interest 135 that the corresponding user interacts with the most, visits frequently or has previously interacted with. The user profile can include points of interest 135 within different geographical locations ranked within the user profile based in part on frequency of use. The vehicle based data processing system 110 can extract the highest ranked or most used points of interest 135 from the user profile and display the points of interest 135 within the map 130. The vehicle based data processing system 110 can extract each of the points of interest 135 within the current geographical location of the vehicle 107 and display the points of interest 135 within the map 130. The vehicle based data processing system 110 can generate the plurality of points of interest 135 based in part on a current geographical location of the vehicle 107 or a desired geographical location of the vehicle 107. The vehicle based data processing system 110 can store the plurality of points of interest 135 in the database 112. The vehicle based data processing system 110 can detect properties of at least one passenger within the vehicle. The passenger can have a user profile. The vehicle based data processing can generate the first map 130 within the navigation application 125 corresponding to the identified passenger. For example, the first map can include points of interest 135 corresponding to the properties of the at least one passenger or a user profile of the at least one passenger within the vehicle 107. The vehicle based data processing system can extract the plurality of points of interest 135 from a third party server 150 and generate maps 130 including the plurality of points of interest 135 from the third party server 150. The vehicle based data processing system 110 can modify one or more points of interest 135 responsive to a change of the location of the vehicle 107. For example, the vehicle based data processing system 110 can dynamically modify one or more points of interest 135 responsive as the vehicle 107 drives through different locations or geographical areas.

The method 500 can include receiving an input (ACT 525). For example, the method 500 can include receiving, by the navigation application 125, an input corresponding to an interaction with a point of interest 135 of the plurality of points of interest 135. The input can be received through an input device 145 of the consolidated interface 105. For example, the input device 145 can communicatively couple with the vehicle based data processing system 110, for example, through a wireless connection. The input device 150 can couple with the vehicle based data processing system 110, for example, through a wired connection. The input device 145 can include buttons or keypads to generate a signal responsive to contact. The signals can correspond to a directional input or motion input to interact with content 140 provided within a respective display 120. The signals can include a selection of a content item 140 provided within a display 120. For example, the signals can include a selection through a climate control menu provided in a display 120 to activate an air conditioning system of the vehicle 107. The signals can include a direction (e.g., right, left, up, down) to relocate or slide content 140 provided within a display 120. For example, the signals can include an instruction to scroll through an entertainment menu provided in a display 120 to find a song to play through the entertainment system of the vehicle 107.

The input can be received through at least one display 120 of the display module 120. For example, the displays 120 can include or correspond to a touch screen. The vehicle based data processing system 110 can identify a touch signal corresponding to the interaction or input. The touch signal can represent of a position within a first display 120 of the display module 115 dedicated to the navigation application 125. The touch signal can be responsive to contact with the position within the first display 120. The positon can correspond to at least one point of interest 135 of the plurality of points of interest 135. For example, the displays 120 can receive an input through contact with a surface of the respective display 120. The vehicle based data processing system 110 can detect a horizontal and vertical orientation of the contact on the display 120. The vehicle based data processing system 110 can map or identify the location of the contact using the horizontal and vertical orientation data. The vehicle based data processing system 110 can determine what content 140 or portion of content 140 is provided within the identified location of the contact. The vehicle based data processing system 110 can generate a request 116 corresponding to the at least one point of interest 135 of the plurality of points of interest 135.

The method 500 can include identifying a point of interest 135 (ACT 530). For example, the method 500 can include identifying, by the vehicle based data processing system 110, at least one point of interest 135 corresponding the received input. The input can be received through the navigation application 125 provided within at least one display 120 of the display module 120. For example, the input can correspond to an interaction with the map 130 of the navigation application 125. The map 130 includes a plurality of points of interest 135 corresponding to a current geographical location of the vehicle 107 or a desired geographical location of the vehicle 107. The interaction can correspond to at least one of: a signal from an input device 145 of the vehicle 107, a signal from a computing device coupled with the vehicle based data processing system 110, and a voice command. The interaction can include contact with a screen displaying the map 130, an audio input, or an input received through the input device 145. The interaction can include a selection of at least one point of interest 135 provided within the map 130. For example, the map 130 can be provided within a display 120 having a touch screen. The vehicle based data processing system 110 can detect a horizontal and vertical orientation of an interaction or contact with the map 130. The vehicle based data processing system 110 can map or identify the location of the interaction or contact using the horizontal and vertical orientation data. The vehicle based data processing system 110 can determine which point of interest 135 is provided at the identified location of the map 130.

The method 500 can include generating a request 116 (ACT 535). For example, the method 500 can include generating, by the navigation application 125, a request 116 responsive the input. The request 116 can identify a third party application 155 corresponding to the point of interest 135. The request 116 can include a function 118 for the third party application 155. For example, the vehicle based data processing system 110 can generate the request 116 to retrieve content 140 from a third party server 150 hosting the third party application 155. The requested content 140 can include data such as, services provided, products provided, contact information (e.g., telephone number, email address) or other information corresponding to the selected point of interest 135. The point of interest 135 may include a hyperlink. Thus, the request 116 can be generated through an interaction with the hyperlink of the respective point of interest 135. The hyperlink can couple the vehicle based data processing system 110 with a third party application 155 hosted by a third party server 150 of the respective point of interest 135.

The method 500 can include transmitting the request 116 (ACT 540). For example, the method 500 can include transmitting, by the vehicle based data processing system 110, the request 116 including the function 118 to the third party application 155. The function 118 can correspond to at least one of: a service provided by the third party application 155, a product provided by the third party application 155 and data corresponding to the third party application 155. The vehicle based data processing system 110 can generate a function 118 to include with the request 116 to the third party server 155. The function 118 can cause a third party application 155 of the third party server 150 to generate the requested content 140 or retrieve the requested content 140 corresponding to the input with the point of interest 135. The vehicle based data processing system 110 can generate the function 118 as a set of instructions to be executed by the third party application 155 or third party server 150 of the point of interest 135. Responsive to the function 118, the third party application 155 or the third party server 150 can generate or retrieve the requested content 140 corresponding to the point of interest 135. For example, the point of interest 135 can correspond to a sandwich shop. The vehicle based data processing system 110 can generate the function 118 having a set of instructions to cause a third party server 150 corresponding to the sandwich shop point of interest 135 to retrieve menu data and price data. The vehicle based data processing system 110 can generate the function 118 having a set of instructions to cause a third party server 150 to generate content 140, such as, a listing of products offered by the respective point of interest 135, a listing of services offered by the respective point of interest 135, advertisements or offers provided by the respective point of interest 135, or other forms of data corresponding to the respective point of interest 135. The vehicle based data processing system 110 can transmit the request 116 to at least one third party server 150. The vehicle based data processing system 110 can transmit the request 116 to a plurality of third party servers 150. For example, each of the third party servers 150 can provide similar services or products. The vehicle based data processing system 110 can request data from each of the third party servers 150 providing similar services or products to compare options or prices.

The method 500 can include receiving content 140 (ACT 545). For example, the method 500 can include receiving responsive to the function 118, by the vehicle based data processing system 110, content 140 from the third party application 155 corresponding to the input. The vehicle based data processing system 110 can receive the content 140 from a plurality of third party servers 150. The vehicle based data processing system 110 can compare the received content 140 to determine which content 140 to provide to or display to a user of the vehicle 107. For example, the vehicle based data processing system 110 can compare the prices of similar goods or services to identify a best priced option to provide to or display to a user of the vehicle 107. The vehicle based data processing system 110 can compare the prices of similar goods or services to identify a listing of multiple best priced options to provide to or display to a user of the vehicle 107. The vehicle based data processing system 110 can receive content 140, such as advertisements, from a plurality of third party servers 150. The vehicle based data processing system 110 can store the received content 140 within the memory 114.

The method 500 can include generating an overlay (ACT 550). For example, the method 500 can include generating, by the vehicle based data processing system 110, overlay portions or an overlay layer to be provided within the map 130 of the navigation application 125. The overlay can include or correspond to a second display 120 generated within another display 120. The overlay can be used to provide content 140 within the map 130 of the navigation application 125. For example, the overlay can include a portion of a display 120 generated by the vehicle based data processing system 110 to provide content 140. The overlay can be generated such that it is smaller than or less prominent than the display 120 the overlay is formed within. For example, the vehicle based data processing system 110 can determine dimensions or a number of pixels to allocate to the overlay. The dimensions or a number of pixels can be selected such that the overlay is provided within the map 130 and that at least one portion of the map 130 is still visible within the vehicle 107 from a viewpoint of a user of the vehicle 107. The overlay can include an advertisement block generated within the map 130 to display content 140 having an advertisement for at least one point of interest 135 of the map 130. The vehicle based data processing system 110 can generate multiple overlay portions or multiple overlay layers to display content 140. The vehicle based data processing system 110 can generate a single overlay portion or single overlay layer to display content 140.

The method 500 can include displaying the content 140 (ACT 555). For example, the method 500 can include displaying, by vehicle based data processing system 110, the content 140 from the third party application within a second display 120 of the plurality of displays 120. The second display can be provided within a portion of the first display 120. The vehicle based data processing system can display the content received from the third party application 155 or third party server 150 within a second display (e.g., overlay portion) generated within the map 130 that is provided within the first display 120. The content 140 can be displayed over at least one portion of the map 130 (e.g., first display 120). The content 140 can be displayed over at least one portion of the map 130 (e.g., first display 120) such that portions of the map 130 remain visible within the vehicle 107 from the viewpoint of a user of the vehicle 107. The vehicle 107 can include an electric, hybrid, autonomous, human operated, or fossil fuel based vehicle such as a car, truck, or motorcycle, as well as other vehicles. For example, the vehicle based data processing system 110 can generate the second display 120 in a corner of the first display 130, a side portion of the first display 120, in a center of the first display 120, or offset from a center of the first display 120. The vehicle based data processing system 110 can generate the second display 120 having smaller dimensions than the first display 120 dedicated to the navigation application 125 and providing the map 130. The vehicle based data processing system 110 can generate the second display 120 such that the second display 120 is allocated less pixels than the first display 120 dedicated to the navigation application 125 and providing the map 130.

The vehicle based data processing system 110 can generate the second display 120 having the content 140 with hyperlinks to the third party application 155 or third party server 150 that provided the content 140. For example, the content 140 can correspond to a menu for coffee or an advertisement for coffee offered by a first server 150. The vehicle based data processing system 110 can generate the second display 120 having the content 140 with hyperlinks the first server 150 such that when a user of the vehicle 107 interacts with (e.g., touches the corresponding portion of the display, clicks on) the content 140, the vehicle based data processing system 110 connects with the first server 150.

The vehicle based data processing system 110 can generate a custom display layout or modify display layout properties responsive to inputs or interactions from a user of the vehicle 107. The vehicle based data processing system 110 can modify the dimensions or pixel value for one or more displays 120 of the display module 115. For example, the vehicle based data processing system 110 can modify a size of the first display 120 providing the navigation application 125 responsive to an input or interaction from a user of the vehicle 107. The dimensions of the first display 120 can be increased to make the navigation application 125 and map 130 appear more prominently to a user of the vehicle 107 (e.g., increase the visibility). The number of pixels allocated to the first display 120 can be increased to make the navigation application 125 and map 130 appear more prominently to a user of the vehicle 107 (e.g., increase the visibility). The dimensions of the first display 120 can be decreased to make the navigation application 125 and map 130 appear less prominent to a user of the vehicle 107 (e.g., increase the visibility) or to increase the visibility of other displays 120 of the display module 115. The number of pixels allocated to the first display 120 can be decreased to make the navigation application 125 and map 130 appear more less visible to a user of the vehicle 107 (e.g., increase the visibility) as compared to other displays 120 of the display module 115.

The vehicle based data processing system 110 can modify a position or location within the display module 115 of one or more displays 120 of the display module 115 responsive to an input or interaction. For example, the input can correspond to an instruction to move the navigation application 125 from a first display to a second or third display 120 of the plurality of display 120 of the display module 115. The vehicle based data processing system 110 can generate an instruction to relocate the navigation application 125 from the first display 120 to the third display 120. The third display 120 can have a different positon within the display module 115 as compared to the first display 120. The vehicle based data processing system 110 can generate an instruction to relocate the content 140 provided within the third display 120 to the first display 120. Thus, the vehicle based data processing system 110 can customize the display layout for a user of the vehicle 107 responsive to one or more interactions by the respective user.

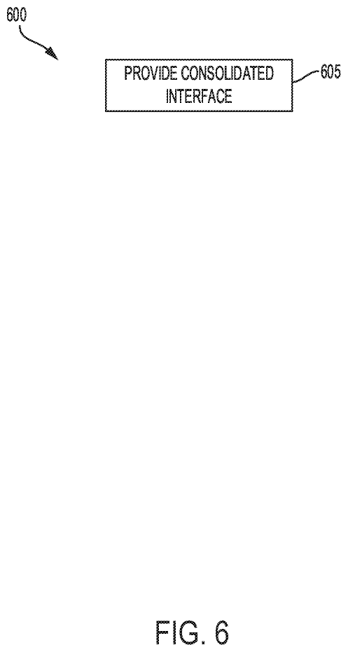

FIG. 6 depicts a method 600. The method 600 can include providing a consolidated interface 105 of a vehicle 107 (ACT 605). The consolidated interface 105 can include a vehicle based data processing system 110. The consolidated interface 105 can include a display module 115 communicatively coupled with the vehicle based data processing system 110. The display module can include a plurality of displays 120 visible within a vehicle 107. The consolidated interface 105 can include a navigation application 125 coupled with the vehicle based data processing system 110. The navigation application 125 can be provided within a first display 120 of the plurality of displays 120. The navigation application 125 can provide a plurality of points of interest 135 corresponding to a location of the vehicle 107. The navigation application 125 can receive an input corresponding to an interaction with a point of interest 135 of the plurality of points of interest 135. The navigation application 125 can generate a request 116 responsive the input. The request 116 can identify a third party application 155 corresponding to the point of interest 135. The request 116 can include a function 118 for the third party application 155. The vehicle based data processing system 110 can transmit the request 116 including the function 118 to the third party application 155. The function 118 can correspond to at least one of: a service provided by the third party application 155, a product provided by the third party application 155 and data corresponding to the third party application 155. The vehicle based data processing system 110 receive content 140, responsive to the function 118, from the third party application 155 corresponding to the input. The vehicle based data processing system 110 can display the content 140 from the third party application 155 within a second display 120 of the plurality of displays 120. The second display 120 can be provided within a portion of the first display 120.

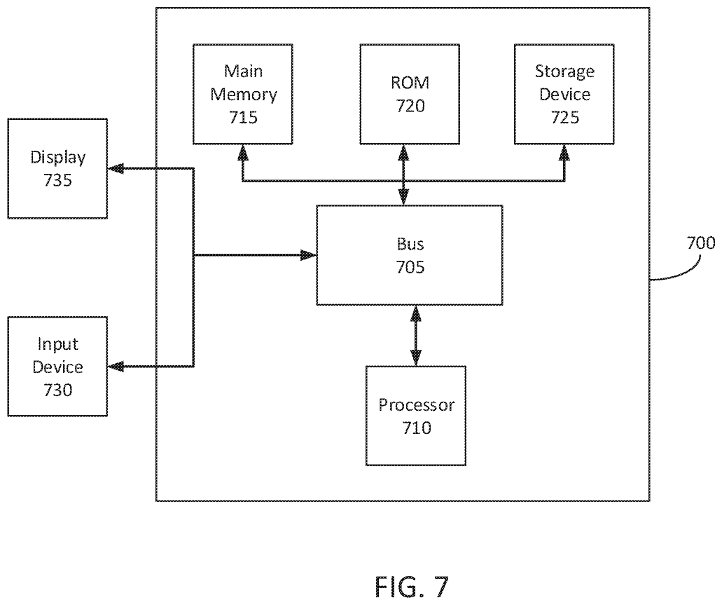

FIG. 7 is a block diagram of an example computer system 700. The computer system or computing device 700 can include or be used to implement the consolidated interface 105, or its components such as the vehicle based data processing system 110 or display module 115. The computing system 700 includes at least one bus 705 or other communication component for communicating information and at least one processor 710 or processing circuit coupled to the bus 705 for processing information. The computing system 700 can also include one or more processors 710 or processing circuits coupled to the bus for processing information. The computing system 700 also includes at least one main memory 715, such as a random access memory (RAM) or other dynamic storage device, coupled to the bus 705 for storing information, and instructions to be executed by the processor 710. The main memory 715 can be or include the memory 114. The main memory 715 can also be used for storing content 140, points of interest 135, position information, vehicle information, command instructions, vehicle status information, environmental information within or external to the vehicle, road status or road condition information, or other information during execution of instructions by the processor 710. The computing system 700 may further include at least one read only memory (ROM) 720 or other static storage device coupled to the bus 705 for storing static information and instructions for the processor 710. A storage device 725, such as a solid state device, magnetic disk or optical disk, can be coupled to the bus 705 to persistently store information and instructions. The storage device 725 can include or be part of the memory 114.

The computing system 700 may be coupled via the bus 705 to a display 735, such as a liquid crystal display, or active matrix display, for displaying information to a user such as a driver of the vehicle 107. An input device 730, such as a keyboard or voice interface may be coupled to the bus 705 for communicating information and commands to the processor 710. The input device 730 can include a touch screen display 735. The input device 730 can also include a cursor control, such as a mouse, a trackball, or cursor direction keys, for communicating direction information and command selections to the processor 710 and for controlling cursor movement on the display 735. The display 735 (e.g., on a vehicle dashboard) can be part of the consolidated interface 105, the display module 115, or displays 120, as well as part of the vehicle 107, for example.

The processes, systems and methods described herein can be implemented by the computing system 700 in response to the processor 710 executing an arrangement of instructions contained in main memory 715. Such instructions can be read into main memory 715 from another computer-readable medium, such as the storage device 725. Execution of the arrangement of instructions contained in main memory 715 causes the computing system 700 to perform the illustrative processes described herein. One or more processors in a multi-processing arrangement may also be employed to execute the instructions contained in main memory 715. Hard-wired circuitry can be used in place of or in combination with software instructions together with the systems and methods described herein. Systems and methods described herein are not limited to any specific combination of hardware circuitry and software.

Although an example computing system has been described in FIG. 7, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components (e.g., display module 115), and the consolidated interface 105. Other groupings that execute similar overall operations are understood to be within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While acts or operations may be depicted in the drawings or described in a particular order, such operations are not required to be performed in the particular order shown or described, or in sequential order, and all depicted or described operations are not required to be performed. Actions described herein can be performed in different orders.

Having now described some illustrative implementations, it is apparent that the foregoing is illustrative and not limiting, having been presented by way of example. Features that are described herein in the context of separate implementations can also be implemented in combination in a single embodiment or implementation. Features that are described in the context of a single implementation can also be implemented in multiple implementations separately or in various sub-combinations. References to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any act or element may include implementations where the act or element is based at least in part on any act or element.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein may be embodied in other specific forms without departing from the characteristics thereof. For example, the vehicle based data processing system can communicatively couple with more than one display module within a vehicle and generate multiple windows for each of the display modules. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

Systems and methods described herein may be embodied in other specific forms without departing from the characteristics thereof. For example, descriptions of positive and negative electrical characteristics may be reversed. For example, elements described as negative elements can instead be configured as positive elements and elements described as positive elements can instead by configured as negative elements. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

1. A consolidated vehicle navigation and information system, the system comprising:
a vehicle based data processing system;
a display module communicatively coupled with the vehicle based data processing system, the display module having at least one display device and a plurality of displays visible within a vehicle on the at least one display device; and
a navigation application coupled with the vehicle based data processing system, the navigation application provided within a first display of the plurality of displays, the navigation application provides a plurality of points of interest that correspond to a location of the vehicle and a user profile of the at least one passenger within the vehicle; and
the navigation application to:
receive an input that corresponds to an interaction with a point of interest of the plurality of points of interest; and
generate a request responsive the input, the request identifying a third party application that corresponds to the point of interest, and the request including a function for the third party application;
the function including a set of instructions to be executed by the third party application to generate content and
the vehicle based data processing system to:
transmit the request including the function to the third party application, the function that corresponds to at least one of: a service provided by the third party application, a product provided by the third party application and data corresponding to the third party application;
receive the content, responsive to the function, from the third party application corresponding to the input; and
display the content from the third party application within a second display of the plurality of displays, the second display provided within a portion of the first display.

2. The system of claim 1, comprising:
the vehicle based data processing system to:
simultaneously provide the navigation application and the third party application as visible within the display module of the vehicle.

3. The system of claim 1, comprising:
the plurality of points of interest are located within a geographical range of the location of the vehicle.

4. The system of claim 1, comprising:
the vehicle based data processing system to:
generate a map within the navigation application corresponding to the location of the vehicle, the map including the plurality of points of interest.

5. The system of claim 1, comprising:
the vehicle based data processing system to:
modify a size of the first display providing the navigation application responsive to the input.

6. The system of claim 1, comprising:
the vehicle based data processing system to:
move the navigation application from the first display to a third display of the plurality of displays of the display module responsive to the input, the third display having a different position within the display module as compared to the first display.

7. The system of claim 1, comprising:
the interaction corresponding to at least one of: a signal from an input device of the vehicle, a signal from a computing device coupled with the vehicle based data processing system, and a voice command.

8. The system of claim 1, comprising:
the navigation application to:
identify a touch signal corresponding to the interaction, the touch signal representative of a position within the first display, the touch signal responsive to contact with the position within the first display, and the position corresponding to at least one point of interest of the plurality of points of interest; and
generate the request corresponding to the at least one point of interest of the plurality of points of interest.

9. The system of claim 1, comprising:
the vehicle based data processing system having a database, and the vehicle based data processing system to:
generate the plurality of points of interest for the vehicle; and
store the plurality of points of interest in the database.

10. The system of claim 1, comprising:
the vehicle based data processing system to:
extract the plurality of points of interest from a third party server; and
generate maps including the plurality of points of interest.

11. The system of claim 1, comprising:
the vehicle based data processing system to:
transmit the request to the third party application executing on a third party server to cause the third party server to generate the content for the third party application executing within the display module.

12. The system of claim 1, comprising:
the vehicle based data processing system to:
generate a first map within the navigation application, the first map having a first subset of points of interest, the first subset corresponding to the location of the vehicle; and
modify one or more points of interest in the first subset of points of interest within the first map responsive to a change of the location of the vehicle.

13. The system of claim 1, comprising:
the vehicle based data processing system to:
detect properties of at least one passenger within the vehicle; and
generate a first map within the navigation application, the first map having points of interest corresponding to the properties of the at least one passenger within the vehicle.

14. The system of claim 1, comprising:
the display module disposed within a dashboard of the vehicle.

15. The system of claim 1, comprising:
the display module disposed within a console of the vehicle.

16. A method of providing a consolidated navigation application within a vehicle, the method comprising:
providing, by a vehicle based data processing system, a plurality of displays of a display module visible within the vehicle, the display module communicatively coupled with the vehicle based data processing system;
executing, by the vehicle based data processing system, a navigation application within a first display of the plurality of displays, the navigation application providing a plurality of points of interest corresponding to a location of the vehicle and a user profile of the at least one passenger within the vehicle;
receiving, by the navigation application, an input corresponding to an interaction with a point of interest of the plurality of points of interest;
generating, by the navigation application, a request responsive the input, the request identifying a third party application corresponding to the point of interest, and the request including a function for the third party application, and the function including a set of instructions to be executed by the third party application to generate content;
transmitting, by the vehicle based data processing system, the request including the function to the third party application, the function corresponding to at least one of: a service provided by the third party application, a product provided by the third party application and data corresponding to the third party application;
receiving responsive to the function, by the vehicle based data processing system, the content from the third party application corresponding to the input; and
displaying, by vehicle based data processing system, the content from the third party application within a second display of the plurality of displays, the second display provided within a portion of the first display.

17. The method of claim 16, comprising:
transmitting, by the vehicle based data processing system, the request to the third party application executing on a third party server to cause the third party server to generate the content for the third party application.

18. The method of claim 16, comprising:
generating, by the vehicle based data processing system, a first map within the navigation application, the first map having a first subset of points of interest, the first subset corresponding to the location of the vehicle; and
modifying, by the vehicle based data processing system, one or more points of interest in the first subset of points of interest within the first map responsive to a change of the location of the vehicle.

19. The method of claim 16, comprising:
detecting, by the vehicle based data processing system, properties of at least one passenger within the vehicle; and
generating, by the vehicle based data processing system, a first map within the navigation application, the first map having points of interest corresponding to the properties of the at least one passenger within the vehicle.

20. A vehicle, comprising:
a consolidated vehicle navigation and information system, the system comprising:
a vehicle based data processing system;
a display module communicatively coupled with the vehicle based data processing system, the display module having a plurality of displays visible within a vehicle; and
a navigation application coupled with the vehicle based data processing system, the navigation application provided within a first display of the plurality of displays, the navigation application providing a plurality of points of interest corresponding to a location of the vehicle and a user profile of the at least one passenger within the vehicle; and
the navigation application to:
receive an input corresponding to an interaction with a point of interest of the plurality of points of interest; and
generate a request responsive the input, the request identifying a third party application corresponding to the point of interest, and the request including a function for the third party application;
the function including a set of instructions to be executed by the third party application to generate content and
the vehicle based data processing system to:
transmit the request including the function to the third party application, the function corresponding to at least one of: a service provided by the third party application, a product provided by the third party application and data corresponding to the third party application;
receive the content, responsive to the function, from the third party application corresponding to the input; and
display the content from the third party application within a second display of the plurality of displays, the second display provided within a portion of the first display.
